(19) United States
(12) Patent Application Publication
(10) Pub. No.: US 2025/0214089 A1
(43) Pub. Date: Jul. 3, 2025

(54) SEPARATION CHIP

(71) Applicant: SCREEN Holdings Co., Ltd., Kyoto (JP)

(72) Inventor: Katsuaki KAWARA, Kyoto-shi (JP)

(21) Appl. No.: 18/975,675

(22) Filed: Dec. 10, 2024

(30) Foreign Application Priority Data
Dec. 27, 2023 (JP) 2023-220868

(51) Int. Cl. B03C 5/02; B03C 5/00

(52) U.S. Cl. CPC B03C 5/026; B03C 5/005; B03C 2201/26

(57) ABSTRACT

A separation chip includes a substrate and a plurality of electrode portions. The plurality of electrode portions are disposed on one-side surface of the substrate, and each of the electrode portions has at least an electrode, and extends in the first direction. The plurality of electrode portions are disposed adjacent to each other in the second direction intersecting the first direction. A channel through which a liquid containing dielectric particles is to flow in a flow direction intersecting the first direction is provided on one side of the plurality of electrode portions. At least one electrode portion and another electrode portion are different from each other in at least one of a cross-sectional shape along the second direction, a dimension in a cross section along the second direction, and a material.

### CROSS REFERENCE TO RELATED APPLICATIONS

This application claims priority based Japanese Patent Application No. 2023-220868 filed on Dec. 27, 2023, the entire contents of which are incorporated herein by reference.

### BACKGROUND OF THE INVENTION

### 1. Field of the Invention

The present invention relates to a separation chip.

### 2. Description of the Related Art

Conventionally, a separation chip that separates specific cells from blood is known. For example, Japanese Patent Application Publication No. 2020-99256 discloses a chip including a dielectrophoresis (DEP) unit that realizes separation and recovery of cells and the like by dielectrophoresis. The DEP unit includes a pair of comb-shaped electrodes facing each other, the electrodes being provided on a channel. By applying an AC voltage between the pair of electrodes, dielectrophoresis is caused. By appropriately adjusting the AC voltage and a frequency to be applied, desired cells such as CTCs are induced and separated.

### SUMMARY OF THE INVENTION

In general, when cells or the like are captured by a dielectrophoretic force using comb-shaped electrodes, an AC voltage and a frequency to be applied are adjusted in accordance with a type of cells to be captured, a medium around the cells, an electrode shape, and the like.

However, since characteristics such as a size and a dielectric constant vary among a plurality of cells, the dielectrophoretic force acting on the cells also varies. For this reason, a portion of the cells to be captured cannot be captured, and a capture rate may decrease.

A preferred embodiment of the present invention provides a separation chip capable of suppressing a decrease in a capture rate of dielectric particles to be captured.

A separation chip according to a preferred embodiment of the present invention includes a substrate and a plurality of electrode portions. The plurality of electrode portions are disposed on one-side surface of the substrate, have at least electrodes, and extend in a first direction. The plurality of electrode portions are disposed adjacent to each other in a second direction intersecting the first direction. A channel through which a liquid containing dielectric particles is to flow in a flow direction intersecting the first direction is provided on one side of the plurality of electrode portions.

In a mode of the present invention, at least one of the electrode portions and another one of the electrode portions are different from each other in at least one of a cross-sectional shape along the second direction, a dimension in a cross section along the second direction, and a material.

In a mode of the present invention, at least one of the electrodes and another one of the electrodes may be different from each other in at least one of a cross-sectional shape along the second direction, a dimension in a cross section along the second direction, and a material.

In a mode of the present invention, the at least one electrode and the other electrode may be different from each other in an electrode width in the cross section along the second direction.

In a mode of the present invention, the other electrode may be disposed downstream of the at least one electrode in the flow direction. The electrode width of the other electrode may be smaller as compared to the electrode width of the at least one electrode.

In a mode of the present invention, each of the electrode portions may have an insulation layer disposed on one-side surface of the electrode. At least one of the insulation layers and another one of the insulation layers may be different from each other in at least one of a cross-sectional shape along the second direction, a dimension in a cross section along the second direction, and a material. In a mode of the present invention, each of the insulation layers may have an opening portion that connects the electrode and the channel. The at least one insulation layer and the other insulation layer may be different from each other in a width of the opening portion in the cross section along the second direction.

In a mode of the present invention, the other insulation layer may be disposed downstream of the at least one insulation layer in the flow direction. The width of the opening portion along the second direction of the other insulation layer may be smaller as compared to the width of the opening portion along the second direction of the at least one insulation layer.

In a mode of the present invention, the one-side surface of the electrode may have a first region and a second region different from the first region. The insulation layer may be disposed on the second region. The first region may be connected to the channel through the opening portion. The first region may be located closer to the substrate than the second region.

In a mode of the present invention, ∇E² between the electrodes adjacent to each other on the downstream side in the flow direction may be larger as compared to ∇E² between the electrodes adjacent to each other on the upstream side in the flow direction. ∇E indicates a gradient of an electric field intensity.

In a mode of the present invention, a distance of at least one between-electrodes-part (a distance between at least one pair of the electrodes adjacent to each other) is different from a distance of another between-electrodes-part (a distance between another pair of the electrodes adjacent to each other).

In a mode of the present invention, the distance of the other between-electrodes-part of the downstream side in the flow direction may be smaller as compared to the distance of the at least one between-electrodes-part on the upstream side in the flow direction.

In a mode of the present invention, each of the electrode portions may have an insulation layer disposed on one-side surface of the electrode. Each of the insulation layers may have an opening portion that connects the electrode and the channel. The one-side surface of each of the electrodes may have a first region and a second region different from the first region. The insulation layer may be disposed on the second region. The first region may be connected to the channel through the opening portion. The first region may be located closer to the substrate than the second region.

In a mode of the present invention, ∇E² between the electrodes adjacent to each other on the downstream side in the flow direction may be larger as compared to ∇E² between the electrodes adjacent to each other on the upstream side in the flow direction. ∇E indicates a gradient of an electric field intensity.

In an aspect of the present invention, ∇E² of the at least one between-electrodes-part (∇E² between at least one pair of the electrodes adjacent to each other) is different from ∇E² of the other between-electrodes-part (∇E² between another pair of the electrodes adjacent to each other). ∇E indicates a gradient of an electric field intensity.

The above-described or yet other objects, characteristics, and effects of the present invention will be clarified from the following description of preferred embodiment with reference to the accompanying drawings.

### BRIEF DESCRIPTION OF THE DRAWINGS

FIG. 1 is a plan view schematically showing a structure of a dielectrophoresis apparatus including a separation chip according to a preferred embodiment of the present invention.

FIG. 2 is an enlarged cross-sectional view schematically showing a cross-sectional structure around teeth portions of the separation chip of the above preferred embodiment.

FIG. 3 is an enlarged cross-sectional view schematically showing a cross-sectional structure around the teeth portions of the separation chip of the above preferred embodiment.

FIG. 4 is a plan view schematically showing a structure around the teeth portions of the separation chip.

FIG. 5 is an enlarged cross-sectional view schematically showing a cross-sectional structure around teeth portions of a separation chip according to a first modified example.

FIG. 6 is an enlarged cross-sectional view schematically showing a structure around teeth portions of a separation chip according to a second modified example.

FIG. 7 is an enlarged cross-sectional view schematically showing a structure around teeth portions of a separation chip according to a third modified example.

FIG. 8 is a view for describing effects of the separation chip of the third modified example, and is an enlarged cross-sectional view schematically showing a structure around the teeth portions of the separation chip of the preferred embodiment shown in FIGS. 1 to 4.

FIG. 9 is an enlarged cross-sectional view schematically showing a structure around the teeth portions of the separation chip of the third modified example.

FIG. 10 is a plan view schematically showing a structure of a separation chip according to a fourth modified example.

FIG. 11 is a plan view schematically showing a structure of a separation chip according to a fifth modified example.

### DETAILED DESCRIPTION OF THE PREFERRED EMBODIMENTS

Hereinafter, a preferred embodiment of the present invention will be described with reference to the drawings. In the drawings, the same or corresponding portions will be given the same reference signs and will not be repeatedly described.

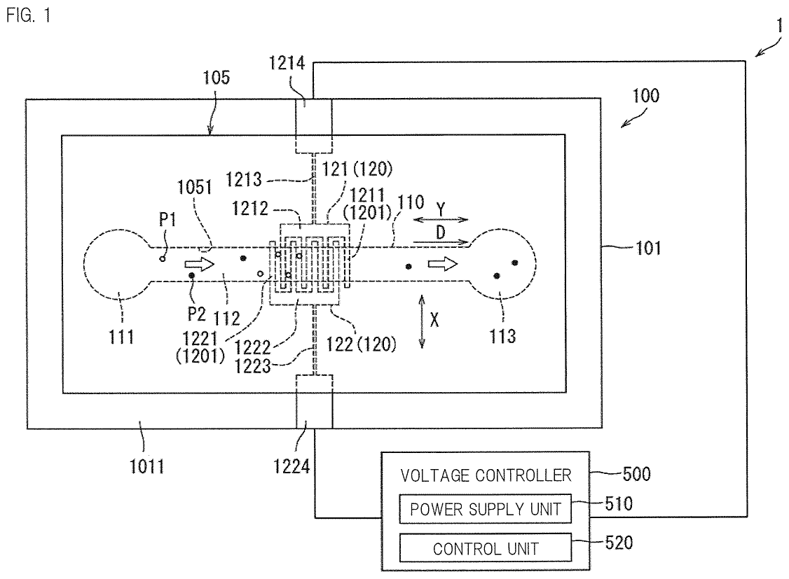

With reference to FIGS. 1 to 4, a dielectrophoresis apparatus 1 including a separation chip 100 according to the preferred embodiment of the present invention will be described. FIG. 1 is a plan view schematically showing a structure of the dielectrophoresis apparatus 1 including the separation chip 100 according to the preferred embodiment of the present invention.

As shown in FIG. 1, the dielectrophoresis apparatus 1 of the preferred embodiment of the present invention includes the separation chip 100 and a voltage controller 500. The dielectrophoresis apparatus 1 causes a dielectrophoresis force to act on dielectric particles P1 contained in a sample liquid, thereby separating the dielectric particles P1 from other particles P2 and collecting the dielectric particles P1. The sample liquid is not particularly limited, and is, for example, blood. The dielectric particles P1 are not particularly limited, and are, for example, cells, proteins, nucleic acids, or microorganisms. The cells are, for example, cancer cells. Also, the sample liquid may be seawater, physiological saline, pure water, or a chemical. The other particles P2 are, for example, dielectric particles of a type different from that of the dielectric particles P1 or non-dielectric particles. As an example, the sample liquid is blood, the dielectric particles P1 are cancer cells, and the other particles P2 are white blood cells. The sample liquid is an example of the “liquid” of the present invention.

The separation chip 100 causes the dielectrophoresis force to act on the dielectric particles P1 contained in the sample liquid, thereby separating the dielectric particles P1 from the other particles P2 and collecting the dielectric particles P1. A diameter of the dielectric particles P1 is, for example, several micrometers (μm) or more and tens of micrometers (μm) or less.

The separation chip 100 includes a substrate 101, a channel 110, and a separation electrode 120. The channel 110 includes a supply portion 111, a separation channel 112, and a collection portion 113. The sample liquid is introduced into the supply portion 111. The supply portion 111 has, for example, an opening. The supply portion 111 is connected to, for example, a supply source of the sample liquid with a tube.

The separation channel 112 connects the supply portion 111 and the collection portion 113 to each other. The sample liquid introduced into the supply portion 111 flows through the separation channel 112 toward the collection portion 113. The collection portion 113 collects the sample liquid that has passed through the separation channel 112. The collection portion 113 may have, for example, an opening. For example, the collection portion 113 may supply the sample liquid to the outside. In the present preferred embodiment, as will be described below, the collection portion 113 collects the sample liquid from which the dielectric particles P1 have been separated (removed).

The separation chip 100 includes a channel cover 105. The channel cover 105 is disposed over the substrate 101. The channel cover 105 has an area smaller than that of the substrate 101. That is, the channel cover 105 is disposed over a part of substrate 101. The channel cover 105 has a recess portion defining the channel 110. The substrate 101 and the channel cover 105 define the channel 110.

The separation electrode 120 is formed of a conductive metal. In the present preferred embodiment, the metal is a conceptual material including an alloy. The separation electrode 120 is disposed at least in the separation channel 112. In other words, the separation electrode 120 overlaps at least the separation channel 112. The separation electrode 120 includes a first electrode 121 and a second electrode 122. The first electrode 121 and the second electrode 122 have, for example, comb shapes opposing each other. The first electrode 121 and the second electrode 122 do not have to have comb shapes.

The first electrode 121 includes a plurality of teeth portions 1211, a first connection portion 1212, a second connection portion 1213, and a pad portion 1214. The teeth portions 1211 are an example of the “electrode” of the present invention.

Each of the teeth portions 1211 extends substantially linearly. The plurality of teeth portions 1211 are disposed substantially parallel to each other. Also, the plurality of teeth portions 1211 extend in a first direction X intersecting a flow direction D in which the channel 110 extends. The flow direction D is a direction in which the sample liquid is to flow. In the present preferred embodiment, the first direction X is substantially orthogonal to the flow direction D. That is, in the present preferred embodiment, the teeth portions 1211 are substantially orthogonal to the channel 110. Also, the plurality of teeth portions 1211 are disposed at predetermined intervals from each other in a second direction Y intersecting the first direction X. In the present preferred embodiment, the second direction Y is orthogonal to the first direction X. Hereinafter, the second direction Y may be referred to as the width direction. In the present preferred embodiment, the second direction Y is parallel to the flow direction D.

The first connection portion 1212 connects the plurality of teeth portions 1211 to each other. The plurality of teeth portions 1211 and the first connection portion 1212 form a comb shape. For example, the plurality of teeth portions 1211 are disposed across the separation channel 112 in a plan view. The first connection portion 1212 is disposed outside the separation channel 112 in a plan view. The plurality of teeth portions 1211 and the first connection portion 1212 are covered with the channel cover 105.

The second connection portion 1213 connects the first connection portion 1212 and the pad portion 1214 to each other. At least a part of the second connection portion 1213 is covered with the channel cover 105. At least a part of the pad portion 1214 is disposed outside the channel cover 105 in a plan view. In the present preferred embodiment, the second connection portion 1213 is covered with the channel cover 105. A part of the pad portion 1214 is disposed outside the channel cover 105 in a plan view. As described above, since at least a part of the pad portion 1214 is not covered with the channel cover 105, the pad portion 1214 can be easily connected electrically to the voltage controller 500.

The second electrode 122 includes a plurality of teeth portions 1221, a first connection portion 1222, a second connection portion 1223, and a pad portion 1224. The teeth portions 1221 are an example of the “electrode” of the present invention.

Each of the teeth portions 1221 extends substantially linearly. The plurality of teeth portions 1221 are disposed substantially parallel to each other. Also, the plurality of teeth portions 1221 are disposed substantially parallel to the plurality of teeth portions 1211. The first connection portion 1222 connects the plurality of teeth portions 1221 to each other. The plurality of teeth portions 1221 and the first connection portion 1222 form a comb shape. For example, the plurality of teeth portions 1221 are disposed across the separation channel 112 in a plan view. The first connection portion 1222 is disposed outside the separation channel 112 in a plan view. The plurality of teeth portions 1221 and the first connection portion 1222 are covered with the channel cover 105.

The second connection portion 1223 connects the first connection portion 1222 and the pad portion 1224 to each other. At least a part of the second connection portion 1223 is covered with the channel cover 105. At least a part of the pad portion 1224 is disposed outside the channel cover 105 in a plan view. In the present preferred embodiment, the second connection portion 1223 is covered with the channel cover 105. A part of the pad portion 1224 is disposed outside the channel cover 105 in a plan view. As described above, since at least a part of the pad portion 1224 is not covered with the channel cover 105, the pad portion 1224 can be easily connected electrically to the voltage controller 500.

The voltage controller 500 is electrically connected to the pad portion 1214 and the pad portion 1224. The voltage controller 500 applies AC voltages corresponding to the type of dielectric particles P1 to the first electrode 121 and the second electrode 122 through the pad portion 1214 and the pad portion 1224. The AC voltage corresponding to the type of dielectric particles P1 is, for example, a frequency that generates an electric field that causes the dielectrophoresis force (attractive force) to specifically act on the dielectric particles P1, and a voltage having a magnitude to the extent that the dielectric particles P1 are not destroyed.

Specifically, the frequency of the AC voltage is set such that a positive dielectrophoresis force (attractive force) acts on the dielectric particles P1 due to the electric field between the first electrode 121 and the second electrode 122. Therefore, a positive dielectrophoretic force acts on the dielectric particles P1, and the dielectric particles P1 are attracted to the teeth portions 1211 and the teeth portions 1221. On the other hand, the frequency of the AC voltage is set such that the dielectrophoresis force does not act or hardly acts on the other particles P2. Hence, the other particles P2 pass through the separation channel 112 and are collected in the collection portion 113. Hereinafter, the teeth portions 1211 and the teeth portions 1221 may be referred to as teeth portions 1201. The teeth portions 1201 are an example of the “electrode” of the present invention.

Successively, the voltage controller 500 will be described with reference to FIG. 1. The voltage controller 500 includes a power supply unit 510 and a control unit 520.

The control unit 520 controls the power supply unit 510. The control unit 520 includes, for example, a processor and a storage device. The processor is, for example, a central processing unit (CPU) or a micro processing unit (MPU). The storage device stores data and a computer program. The storage device includes a main storage device such as a semiconductor memory and an auxiliary storage device such as a semiconductor memory, a solid state drive, and/or a hard disk drive. The storage device may include removable media. The storage device corresponds to an example of a non-transitory computer readable storage medium.

The power supply unit 510 generates AC voltages corresponding to the dielectric particles P1 which are separation targets. The power supply unit 510 applies AC voltages to the first electrode 121 and the second electrode 122 through the pad portion 1214 and the pad portion 1224. The power supply unit 510 is, for example, a signal generator such as a function generator.

By applying the AC voltage corresponding to the dielectric particles P1 to the first electrode 121 and the second electrode 122 by the power supply unit 510, the dielectrophoretic force (attractive force) acts on the dielectric particles P1. Consequently, the dielectric particles P1 are attracted to the teeth portions 1201 (the teeth portions 1211 and the teeth portions 1221), and the dielectric particles P1 are separated from the other particles P2. In the present preferred embodiment, the dielectric particles P1 are captured by the teeth portions 1201, and the other particles P2 pass through the separation channel 112 and are collected by the collection portion 113.

The voltage controller 500 may have a function of measuring electrical characteristics (impedance or the like) between the first electrode 121 and the second electrode 122. Also, the voltage controller 500 may include, for example, a source measure unit.

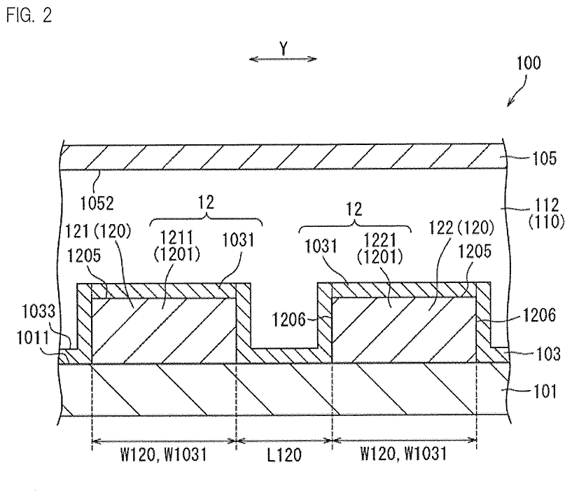

Next, a structure of the separation chip 100 will be further described with reference to FIG. 2. FIG. 2 is an enlarged cross-sectional view schematically showing a cross-sectional structure around the teeth portions 1201 of the separation chip 100 of the present preferred embodiment.

As shown in FIG. 2, the separation chip 100 includes an insulation film 103 in addition to the substrate 101, the separation electrode 120, and the channel cover 105. The substrate 101 is, for example, a glass substrate. A material of the substrate 101 is, for example, quartz glass. However, the material of the substrate 101 is not limited to quartz glass. The substrate 101 has, for example, a substantially rectangular flat plate shape. However, the shape of the substrate 101 is not limited to the flat plate shape.

The separation electrode 120 is disposed on one-side surface 1011 of the substrate 101. A material of the separation electrode 120 is, for example, a metal such as aluminum, copper, and/or titanium. However, the material of the separation electrode 120 may be a metal other than aluminum, copper, and/or titanium. For example, the material of the separation electrode 120 may be a metal such as indium, tin, molybdenum, silver, chromium, tantalum, and/or silicon. Also, the material of the separation electrode 120 may be other than a metal, and may include, for example, an oxide such as a metal oxide, or a semiconductor. Also, a front surface of the separation electrode 120 may be oxidized. Also, the separation electrode 120 may be formed of, for example, indium tin oxide (ITO). The material of the separation electrode 120 is not particularly limited as long as the separation electrode 120 has conductivity.

The separation electrode 120 has a substantially rectangular shape in a cross-sectional view. The separation electrode 120 has one-side surface 1205 and a pair of side surfaces 1206. The one-side surface 1205 is a surface on one side of the separation electrode 120 (a side opposite to the substrate 101). In the present preferred embodiment, the one-side surface 1205 of the separation electrode 120 is a surface that can be seen when the separation electrode 120 is viewed from the channel 110 side. Also, in the present preferred embodiment, the one-side surface 1205 of the separation electrode 120 is a surface substantially parallel to the one-side surface 1011 of the substrate 101.

The pair of side surfaces 1206 are connected to the one-side surface 1205. The pair of side surfaces 1206 extend from an end portion of the one-side surface 1205 in the second direction Y toward the substrate 101.

The insulation film 103 covers at least a part of the one-side surface 1205 of the separation electrode 120. In the present preferred embodiment, the insulation film 103 covers at least the entire surface of the one-side surface 1205 of the teeth portion 1201. Also, the insulation film 103 covers a portion of the one-side surface 1011 of the substrate 101, where the separation electrode 120 is not disposed, and at least a part of the separation electrode 120. The insulation film 103 does not cover at least a portion of the pad portions 1214 and 1224 which is connected to the voltage controller 500. Also, the insulation film 103 covers at least the side surfaces 1206 of the teeth portion 1201 as well.

The insulation film 103 has an insulating property. A material of the insulation film 103 is, for example, an oxide film such as a silicon oxide film, a nitride film such as a silicon nitride film, or a resin. In the present preferred embodiment, the insulation film 103 is a silicon oxide film. Also, a thickness and the material of the insulation film 103 affect the electric field formed by the separation electrode 120. That is, it is also possible to control the electric field formed by the teeth portion 1201 of the separation electrode 120 depending on the thickness and the material of the insulation film 103. The insulation film 103 also functions as a protective film that suppresses an electrochemical reaction from occurring between the teeth portion 1201 of the separation electrode 120 and the sample liquid.

In the present preferred embodiment, the insulation film 103 includes a plurality of cover portions 1031. The cover portion 1031 is a portion of the insulation film 103 disposed on the one-side surface 1205 of the teeth portion 1201. The cover portion 1031 is an example of the “insulation layer” of the present invention.

In the present preferred embodiment, the teeth portion 1201 and the cover portion 1031 constitute the electrode portion 12. In other words, the separation chip 100 includes the plurality of electrode portions 12, and each of the electrode portions 12 includes the teeth portion 1201 and the cover portion 1031. Therefore, the electrode portion 12 extends along the first direction X. The plurality of electrode portions 12 are disposed adjacent to each other in the second direction Y. The channel 110 is provided on one side of the plurality of electrode portions 12.

A thickness of the teeth portion 1201 of the electrode portion 12 is not particularly limited. The teeth portion 1201 has a thickness of, for example, several nanometers (nm) or more and several micrometers (μm) or less. A width of the teeth portion 1201 is not particularly limited. The teeth portion 1201 has, for example, a width of several tens micrometers (μm) or more and several hundreds micrometers (μm) or less. Also, a thickness of the cover portion 1031 of the electrode portion 12 is not particularly limited. The cover portion 1031 has a thickness of, for example, several hundreds nanometers (nm) or more and several micrometers (μm) or less. Also, a distance between the adjacent teeth portions 1201 is not particularly limited. The distance between the adjacent teeth portions 1201 is, for example, 10 micrometers (μm) or more and 100 micrometers (μm) or less. A detailed structure of the electrode portion 12 will be described later.

The channel cover 105 is disposed over, for example, one-side surface 1033 of the insulation film 103. A part of the channel cover 105 may be disposed over the one-side surface 1011 of the substrate 101. The channel cover 105 covers one side of the separation electrode 120 and the insulation film 103 (opposite side to the substrate 101). Also, the channel cover 105 defines the channel 110. Specifically, the channel cover 105 includes a side wall 1051 (see FIG. 1) and a ceiling 1052. The side wall 1051 and the ceiling 1052 define the channel 110 in which the sample liquid is to flow. The side wall 1051 surrounds at least a part of the separation electrode 120 in a plan view.

A material of the channel cover 105 is not particularly limited, and is, for example, a silicone-based resin. In the present preferred embodiment, the material of the channel cover 105 is polydimethylsiloxane (PDMS). In a case where the channel cover 105 is formed of PDMS, the channel cover 105 is firmly bonded between the insulation film 103 and the front surface of substrate 101 by performing plasma processing on the channel cover 105, the insulation film 103, and the front surface of substrate 101.

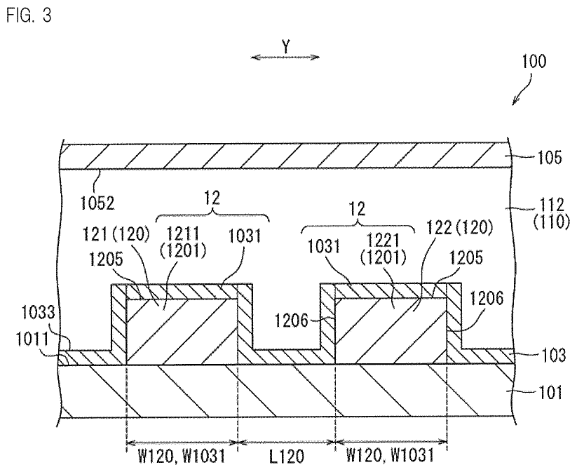

Next, the detailed structure of the electrode portion 12 will be described with reference to FIGS. 2 and 3. FIG. 3 is an enlarged cross-sectional view schematically showing a cross-sectional structure around the teeth portions 1201 of the separation chip 100 of the present preferred embodiment.

As shown in FIGS. 2 and 3, at least one electrode portion 12 and the other electrode portion 12 are different from each other in at least one of a cross-sectional shape along the second direction Y, a dimension in a cross section along the second direction Y, and a material. In the present preferred embodiment, the at least one electrode portion 12 and the other electrode portion 12 are different from each other in the dimension in the cross section along the second direction Y.

Also, the at least one teeth portion 1201 and the other teeth portion 1201 are different from each other in at least one of a cross-sectional shape along the second direction Y, a dimension in a cross section along the second direction Y, and a material. In the present preferred embodiment, the at least one teeth portion 1201 and the other teeth portion 1201 are different from each other in the dimension in the cross section along the second direction Y.

Also, the at least one teeth portion 1201 and the other teeth portion 1201 are different from each other in an electrode width W120 in the cross section along the second direction Y. In the present preferred embodiment, the other teeth portion 1201 is disposed downstream of the at least one teeth portion 1201 in the flow direction D.

Hereinafter, a specific description will be given. FIG. 2 shows, for example, a structure around the electrode portion 12 disposed on the upstream side (left side in FIG. 1) in the flow direction D among the plurality of electrode portions 12. FIG. 3 shows, for example, the structure around the electrode portion 12 disposed on the downstream side (right side in FIG. 1) in the flow direction D among the plurality of electrode portions 12. At least one teeth portion 1201 (here, two teeth portions 1201 shown in FIG. 2) and the other teeth portion 1201 (here, two teeth portions 1201 shown in FIG. 3) are different from each other in the electrode width W120 along the second direction Y. In the present preferred embodiment, the electrode width W120 of the other teeth portion 1201 (see FIG. 3) is smaller as compared to the electrode width W120 of the at least one teeth portion 1201 (see FIG. 2).

In the present preferred embodiment, the at least one cover portion 1031 (here, two cover portions 1031 shown in FIG. 2) and the other cover portion 1031 (here, two cover portions 1031 shown in FIG. 3) are different from each other in at least one of a cross-sectional shape along the second direction Y, a dimension in a cross section along the second direction Y, and a material. In the present preferred embodiment, the at least one cover portion 1031 and the other cover portion 1031 are different from each other in the dimension in the cross section along the second direction Y.

Also, the at least one cover portion 1031 (here, two cover portions 1031 shown in FIG. 2) and the other cover portion 1031 (here, two cover portions 1031 shown in FIG. 3) are different from each other in a width along the second direction Y. In the present preferred embodiment, a width W1031 of the other cover portion 1031 (see FIG. 3) is smaller as compared to a width W1031 of the at least one cover portion 1031 (see FIG. 2). In the present preferred embodiment, the width W1031 is the same size as the electrode width W120. Also, in the present preferred embodiment, a distance L120 between all electrodes (between the adjacent teeth portions 1201) is the same.

Next, the dielectrophoretic force (attractive force) acting on the dielectric particles P1 by the electric field between the first electrode 121 and the second electrode 122 will be described. The dielectrophoresis force is represented by the following general Expression (1).

$$F = 2 π {r}^{3} {ε}_{m} Re [ K ( ω ) ] ∇ {E}^{2} \qquad ( 1 )$$

Here, F represents the dielectrophoresis force. r represents a radius of the dielectric particle. εₘ represents a real part of a dielectric constant of a surrounding medium. ω represents an angular frequency. K(ω) represents a Clausius-Mossotti function. E represents an electric field intensity. ∇E represents a gradient of the electric field intensity.

πr³εₘRe [K(ω)] in the above Expression (1) is determined by the dielectric particles P1 and the medium. Meanwhile, ∇E² is determined on the basis of the electrode portion 12. Therefore, as described above, ∇E² of at least one between-electrodes-part (between the adjacent teeth portions 1201) is different from ∇E² of another between-electrodes-part (between the adjacent teeth portions 1201) because the at least one electrode portion 12 and the other electrode portion 12 are different from each other in at least one of the cross-sectional shape along the second direction Y, the dimension in the cross section along the second direction Y, and the material.

In the present preferred embodiment, ∇E² between the teeth portions 1201 adjacent to each other on the downstream side in the flow direction D is larger as compared to ∇E² between the teeth portions 1201 adjacent to each other on the upstream side in the flow direction D.

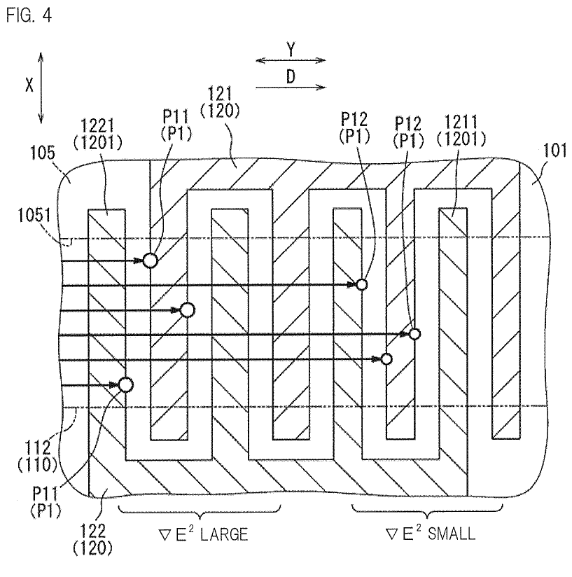

Next, a capture of the dielectric particles P1 by the separation chip 100 of the present preferred embodiment will be described with reference to FIG. 4. FIG. 4 is a plan view schematically showing a structure around the teeth portions 1201 of the separation chip 100. In FIG. 4, the teeth portions 1201 are hatched in order t facilitate understanding. Also, in FIG. 4, in order to facilitate understanding, the channel cover 105, the insulation film 103, and the like are omitted.

Also, here, in order to facilitate understanding, it is assumed that the dielectric particles P1 having a relatively large πr³εₘRe [K(ω)] in the above Expression (1) are dielectric particles P11, and the dielectric particles P1 having a relatively small πr³εₘRe [K(ω)] are dielectric particles P12. Also, it is assumed that ∇E² between the electrodes (between the adjacent teeth portions 1201) on the downstream side is larger as compared to ∇E² between the electrodes (between the adjacent teeth portions 1201) on the upstream side.

As shown in FIG. 4, when a liquid containing the dielectric particles P11 and the dielectric particles P12 flows through the channel 110, the dielectric particles P11 are captured by the teeth portions 1201 on the upstream side. On the other hand, the dielectric particles P12 are not captured by the teeth portions 1201 on the upstream side, and pass through the teeth portions 1201 on the upstream side. Then, the dielectric particles P12 are captured by the teeth portions 1201 on the downstream side.

Here, the example in which a magnitude of ∇E² is set in two stages has been described, but the present invention is not limited thereto. The separation chip 100 may be configured such that the magnitude of ∇E² can be set in three or more stages. That is, for example, the electrode width W120 may be set in three or more stages.

In the present preferred embodiment, as described above, the at least one electrode portion 12 and the other electrode portion 12 are different from each other in at least one of the cross-sectional shape along the second direction Y, the dimension in the cross section along the second direction Y, and the material. Therefore, ∇E² of at least one between-electrodes-part is different from ∇E² of another between-electrodes-part. Therefore, the magnitude of generated between the plurality of electrodes (between the teeth portions 1201 adjacent to each other) can be varied. Therefore, even when there are variations in characteristics such as a size and a dielectric constant between the plurality of dielectric particles P1, and there are the dielectric particles P12 having a relatively small πr³εₘRe [K(ω)] in the above Expression (1) among the plurality of dielectric particles P1, the dielectric particles P12 can be captured by the teeth portions 1201 where a relatively large ∇E² is generated. Therefore, a decrease in a capture rate of the dielectric particles P1 to be captured can be suppressed.

Also, as described above, the at least one teeth portion 1201 and the other teeth portion 1201 are different from each other in at least one of the cross-sectional shape along the second direction Y, the dimension in the cross section along the second direction Y, and the material. Therefore, the at least one electrode portion 12 and the other electrode portion 12 can be easily differentiated from each other in at least one of the cross-sectional shape along the second direction Y, the dimension in the cross section along the second direction Y, and the material.

Also, as described above, the at least one teeth portion 1201 and the other teeth portion 1201 are different from each other in the electrode width W120 in the cross section along the second direction Y. Therefore, ∇E² generated in at least one between-electrodes-part and ∇E² generated in another between-electrodes-part can be easily differentiated from each other.

As described above, the other teeth portion 1201 is disposed downstream of the at least one teeth portion 1201 in the flow direction D, and the electrode width W120 of the other teeth portion 1201 is smaller as compared to the electrode width W120 of the at least one teeth portion 1201. Therefore, ∇E² generated on the downstream side in the flow direction D can be made larger as compared to ∇E² generated on the upstream side in the flow direction D. Therefore, the dielectric particles P1 that have not been captured on the upstream side in the flow direction D can be easily captured on the downstream side in the flow direction D.

Also, ∇E² generated on the upstream side in the flow direction D is smaller as compared to ∇E² generated on the downstream side in the flow direction D, so that the dielectric particles P11 are captured by the teeth portions 1201 on the upstream side. Therefore, it is possible to suppress the dielectric particles P11 from reaching the teeth portions 1201 having relatively large ∇E². That is, the relatively large “πr³εₘRe [K(ω)]” and the relatively large “∇E²” can suppress the dielectrophoretic force from becoming too large. Thus, for example, it is possible to suppress the dielectric particles P11 from being crushed or the dielectric particles P11 from being fixed to the teeth portions 1201.

### First Modified Example

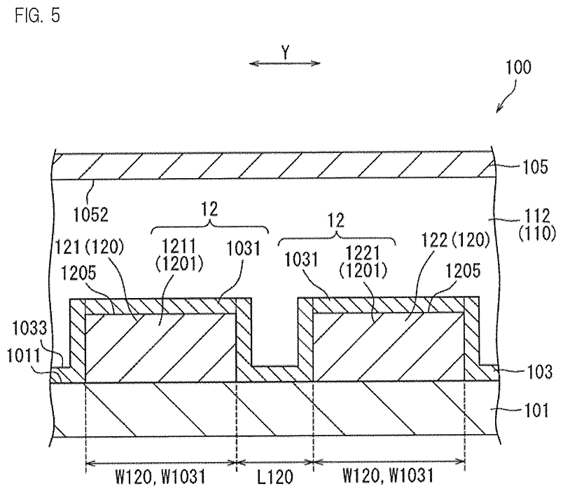

Next, a separation chip 100 according to a first modified example will be described with reference to FIGS. 2 and 5. FIG. 5 is an enlarged cross-sectional view schematically showing a cross-sectional structure around teeth portions 1201 of the separation chip 100 according to the first modified example. In the first modified example, a distance between electrodes is different unlike the above preferred embodiment.

As shown in FIGS. 2 and 5, in the separation chip 100 of the first modified example, unlike the above preferred embodiment, all electrode portions 12 have the same cross-sectional shape along the second direction Y, the same dimension in the cross section along the second direction Y, and the same material. Specifically, the teeth portions 1201 of all electrode portions 12 have the same cross-sectional shape along the second direction Y, the same dimension in the cross section along the second direction Y, and the same material. Also, the cover portions 1031 of all electrode portions 12 have the same cross-sectional shape along the second direction Y, the same dimension in the cross section along the second direction Y, and the same material.

Here, in the first modified example, the distance L120 of at least one between-electrodes-part (here, between the two teeth portions 1201 shown in FIG. 2) is different from the distance L120 of another between-electrodes-part (here, between the two teeth portions 1201 shown in FIG. 5).

Also, in the first modified example, as compared to the distance L120 of at least one between-electrodes-part on the upstream side in the flow direction D, the distance L120 of another between-electrodes-part on the downstream side in the flow direction D is smaller. In other words, as compared to the distance L120 between the teeth portions 1201 adjacent to each other on the upstream side in the flow direction D, the distance L120 between the teeth portions 1201 adjacent to each other on the downstream side in the flow direction D is smaller.

In the first modified example, ∇E² of at least one between-electrodes-part is different from ∇E² of another between-electrodes-part, similarly to the above preferred embodiment. Also, in the first modified example, as compared to ∇E² between the teeth portions 1201 adjacent to each other on the upstream side in the flow direction D, ∇E² between the teeth portions 1201 adjacent to each other on the downstream side in the flow direction D is larger.

In the first modified example, as described above, the distance L120 of at least one between-electrodes-part is different from the distance L120 of another between-electrodes-part. Therefore, similarly to the above preferred embodiment, the magnitude of ∇E² generated between the plurality of electrodes can be varied. Therefore, a decrease in a capture rate of the dielectric particles P1 to be captured can be suppressed.

In the first modified example, as described above, as compared to the distance L120 of at least one between-electrodes-part on the upstream side in the flow direction D, the distance L120 of another between-electrodes-part on the downstream side in the flow direction D is smaller. Therefore, ∇E² generated on the downstream side in the flow direction D can be made larger as compared to ∇E² generated on the upstream side in the flow direction D. Thus, the dielectric particles P1 that have not been captured on the upstream side in the flow direction D can be captured on the downstream side in the flow direction D.

Also, ∇E² generated on the upstream side in the flow direction D is smaller as compared to ∇E² generated on the downstream side in the flow direction D, so that the dielectric particles P11 are captured by the teeth portions 1201 on the upstream side. Therefore, it is possible to suppress the dielectric particles P11 from reaching the teeth portions 1201 having relatively large ∇E². Thus, for example, it is possible to suppress the dielectric particles P11 from being crushed or the dielectric particles P11 from being fixed to the teeth portions 1201.

Other configurations and effects of the first modified example are the same as those of the above preferred embodiment.

### Second Modified Example

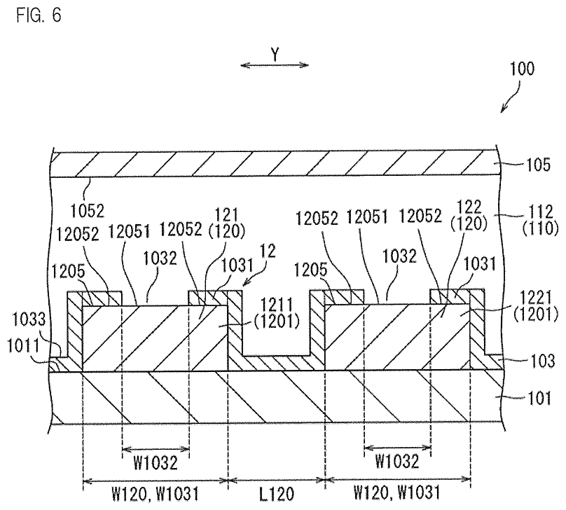

Next, a separation chip 100 according to a second modified example will be described with reference to FIG. 6. FIG. 6 is an enlarged cross-sectional view schematically showing a structure around teeth portions 1201 of the separation chip 100 according to the second modified example. In the second modified example, unlike the above preferred embodiment and the first modified example, an opening portion 1032 is formed in the cover portion 1031 of the insulation film 103.

As shown in FIG. 6, in the second modified example, the one-side surface 1205 of the teeth portion 1201 has a first region 12051 and a second region 12052 different from the first region 12051. Specifically, the one-side surface 1205 has the first region 12051 located at the center in the width direction and a pair of second regions 12052 disposed outward in the width direction with respect to the first region 12051.

In the second modified example, unlike the above preferred embodiment and the first modified example, every distance L120 between electrodes is the same.

The insulation film 103 covers at least a part of the one-side surface 1205 of the teeth portion 1201. In the second modified example, a thickness of the insulation film 103 on the first region 12051 of the teeth portion 1201 is smaller than a thickness of the insulation film 103 on the second region 12052 of the teeth portion 1201. In the second modified example, the thickness of the insulation film 103 on the first region 12051 of the teeth portion 1201 is zero. The thickness of the insulation film 103 on the first region 12051 may not be zero.

Specifically, the insulation film 103 has the opening portion 1032 that connects the first region 12051 of the teeth portion 1201 and the channel 110. That is, in the second modified example, the insulation film 103 is not formed on the first region 12051. The opening portion 1032 is located on the first region 12051 and penetrates the insulation film 103.

In the second modified example, similarly to the above preferred embodiment and the first modified example, the at least one cover portion 1031 and the other cover portion 1031 are different from each other in at least one of the cross-sectional shape along the second direction Y, the dimension in the cross section along the second direction Y, and the material. Also, in the second modified example, the at least one cover portion 1031 and the other cover portion 1031 are different from each other in a width W1032 of the opening portion 1032 in the cross section along the second direction Y.

Also, in the second modified example, the width W1032 of the opening portion 1032 is the same size as a width W121 of the first region 12051. Also, each of the second regions 12052 has the same width. That is, the width of the teeth portion 1201 on the downstream side is smaller than the width of the teeth portion 1201 on the upstream side.

Other configurations of the second modified example are the same as those of the above preferred embodiment and the first modified example.

In the second modified example, as described above, the at least one cover portion 1031 and the other cover portion 1031 are different from each other in at least one of the cross-sectional shape along the second direction Y, the dimension in the cross section along the second direction Y, and the material. Therefore, the at least one electrode portion 12 and the other electrode portion 12 can be easily differentiated from each other in at least one of the cross-sectional shape along the second direction Y, the dimension in the cross section along the second direction Y, and the material.

In the second modified example, as described above, the at least one cover portion 1031 and the other cover portion 1031 are different from each other in the width W1032 of the opening portion 1032 in the cross section along the second direction Y. Therefore, ∇E² generated in at least one between-electrodes-part and ∇E² generated in another between-electrodes-part can be easily differentiated from each other.

Other effects of the second modified example are the same as those of the above preferred embodiment and the first modified example.

### Third Modified Example

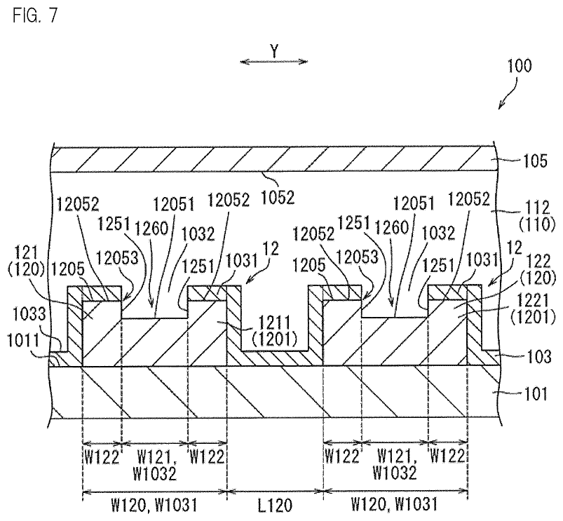

Next, a separation chip 100 according to a third modified example will be described with reference to FIG. 7. FIG. 7 is an enlarged cross-sectional view schematically showing a structure around teeth portions 1201 of the separation chip 100 according to the third modified example. In the third modified example, unlike the above preferred embodiment, the first modified example, and the second modified example, the teeth portions 1201 have a substantially dent or concave shape in a cross-sectional view.

As shown in FIG. 7, in the third modified example, similarly to the second modified example, the one-side surface 1205 of the teeth portion 1201 has the first region 12051 and the second region 12052 different from the first region 12051.

In the third modified example, a step 12053 is formed on the one-side surface 1205 of the teeth portion 1201. Also, in the third modified example, the electrode portions 12 and the teeth portions 1201 have a dent or concave shape in a cross-sectional view. Specifically, the pair of second regions 12052 respectively extend inward in the width direction from the pair of side surfaces 1206. The first region 12051 is disposed substantially parallel to the second regions 12052 between the pair of second regions 12052. The first region 12051 is disposed at a position closer to the substrate 101 than the pair of second regions 12052. The teeth portion 1201 has a pair of connection surfaces 1251, and the pair of connection surfaces 1251 connect the pair of second regions 12052 and the first region 12051. A dent or concave portion 1260 is formed in the teeth portion 1201 by the first region 12051 and the pair of connection surfaces 1251.

Similarly to the second modified example, the insulation film 103 covers at least a part of the one-side surface 1205 of the teeth portion 1201. Also, the thickness of the insulation film 103 on the first region 12051 of the teeth portion 1201 is smaller than the thickness of the insulation film 103 on the second region 12052 of the teeth portion 1201. In the third modified example, the thickness of the insulation film 103 on the first region 12051 of the teeth portion 1201 is zero.

Specifically, similarly to the second modified example, the insulation film 103 has the opening portion 1032 that connects the first region 12051 of the teeth portion 1201 and the channel 110. That is, in the third modified example, the insulation film 103 is not formed on the first region 12051. The opening portion 1032 is located on the first region 12051 and penetrates the insulation film 103.

Also, the insulation film 103 is not formed on at least a part of the connection surface 1251. That is, at least a part of the connection surface 1251 is joined to the channel 110 without the insulation film 103 interposed therebetween. In the third modified example, the insulation film 103 is not formed on the connection surface 1251.

In the third modified example, similarly to the above preferred embodiment, the first modified example, and the second modified example, the at least one electrode portion 12 and the other electrode portion 12 are different from each other in at least one of the cross-sectional shape along the second direction Y, the dimension in the cross section along the second direction Y, and the material. Also, the at least one electrode portion 12 and the other electrode portion 12 are different from each other in the dimension in the cross section along the second direction Y.

Also, the at least one teeth portion 1201 and the other teeth portion 1201 are different from each other in at least one of the cross-sectional shape along the second direction Y, the dimension in the cross section along the second direction Y, and the material. In the third modified example, the at least one teeth portion 1201 and the other teeth portion 1201 are different from each other in the dimension in the cross section along the second direction Y.

Also, the at least one teeth portion 1201 and the other teeth portion 1201 are different from each other in an electrode width W120 in the cross section along the second direction Y. In the third modified example, the other teeth portion 1201 is disposed more downstream side than the at least one teeth portion 1201 in the flow direction D.

In the third modified example, the first region 12051 of the at least one teeth portion 1201 and the first region 12051 of the other teeth portion 1201 are different from each other in the width W121 along the second direction Y. In the third modified example, the width W121 of the first region 12051 of the other teeth portion 1201 on the downstream side in the flow direction D is smaller as compared to the width W121 of the first region 12051 of the at least one teeth portion 1201 on the upstream side in the flow direction D. Also, widths W122 in the cross section along the second direction Y of all second regions 12052 of the teeth portions 1201 are the same. Therefore, the electrode width W120 of the other teeth portion 1201 on the downstream s side in the flow direction D is smaller as compared to the electrode width W120 of the at least one teeth portion 1201 on the upstream side in the flow direction D. In the third modified example, the width W121 of the first region 12051 is the same size as the width W1032 of the opening portion 1032.

Other configurations of the third modified example are the same as those of the above preferred embodiment, the first modified example, and the second modified example.

In the third modified example, as described above, the width W121 of the first region 12051 of the other teeth portion 1201 on the downstream side in the flow direction D is smaller as compared to the width W121 of the first region 12051 of the at least one teeth portion 1201 on the upstream side in the flow direction D. In other words, the width W1032 of the opening portion 1032 along the second direction Y of the other cover portion 1031 is smaller as compared to the width W1032 of the opening portion 1032 along the second direction Y of the at least one cover portion 1031. Therefore, ∇E² generated on the downstream side in the flow direction D can be easily made larger as compared to ∇E² generated on the upstream side in the flow direction D. Therefore, the dielectric particles P1 that have not been captured on the upstream side in the flow direction D can be easily captured on the downstream side in the flow direction D.

Also, ∇E² generated on the upstream side in the flow direction D is smaller as compared to ∇E² generated on the downstream side in the flow direction D, so that the dielectric particles P11 are captured by the teeth portions 1201 on the upstream side. Therefore, it is possible to suppress the dielectric particles P11 from reaching the teeth portions 1201 having relatively large ∇E². Thus, for example, it is possible to suppress the dielectric particles P11 from being crushed or the dielectric particles P11 from being fixed to the teeth portions 1201.

In the third modified example, as described above, the first region 12051 is connected to the channel 110 through the opening portion 1032, and the first region 12051 is located closer to the substrate 101 than the second region 12052. Therefore, the electrode portion 12 and the teeth portion 1201 can be formed in a dent or concave shape, and the following effects are exhibited.

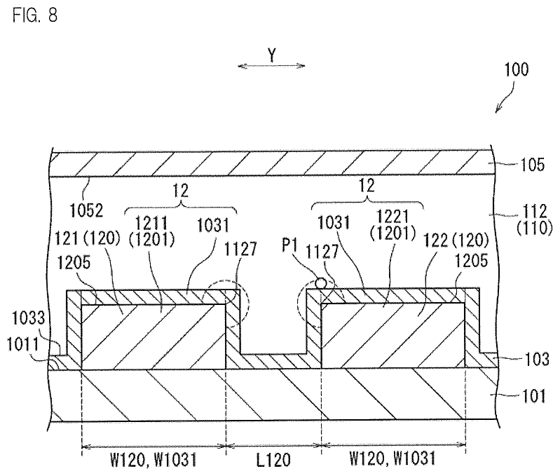

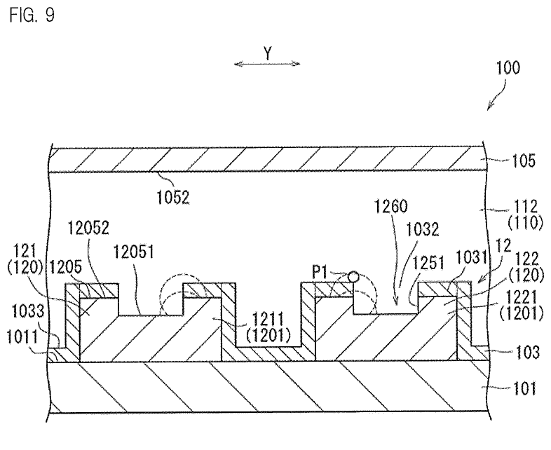

Next, the effect of forming the electrode portion 12 and the teeth portion 1201 of the separation chip 100 of the third modified example into a dent or concave shape will be described with reference to FIGS. 8 and 9. Here, the effect achieved due to the separation chip 100 of the third modified example will be described as compared with the separation chip 100 of the preferred embodiment shown in FIGS. 1 to 4. FIG. 8 is a view for describing the effect of the separation chip 100 of the third modified example, and is an enlarged cross-sectional view schematically showing a structure around the teeth portions 1201 of the separation chip 100 of the preferred embodiment shown in FIGS. 1 to 4. FIG. 9 is an enlarged cross-sectional view schematically showing a structure around the teeth portions 1201 of the separation chip 100 of the third modified example. At a corner portion of an electrode, an electric field is strong and a gradient of an electric field intensity increases. Therefore, in FIGS. 8 and 9, in order to facilitate understanding of the invention, an image of a region where the force (attractive force) attracting the dielectric particles is strong is indicated by broken lines.

First, the separation chip 100 of the above preferred embodiment will be described with reference to FIG. 8. As shown in FIG. 8, in the separation chip 100 of the above preferred embodiment, the teeth portion 1201 has a substantially rectangular shape in a cross-sectional view. That is, a step is not formed on the one-side surface 1205 of the teeth portion 1201. Also, the insulation film 103 has a substantially uniform thickness on the one-side surface 1205 of the teeth portion 1201. Also, the opening portion 1032 is not formed in the insulation film 103.

In the separation chip 100 of the above preferred embodiment, regarding ∇E² between the two teeth portions 1201, ∇E² around adjacent corner portions 1127 of the two teeth portions 1201 is estimated to be the largest. Therefore, the dielectric particles P1 are attracted to the corner portions 1127. Thus, the dielectric particles P1 are attracted to end portions of the teeth portions 1201 in the width direction. In the separation chip 100 of the above preferred embodiment, even if a frequency and a voltage are changed, a position where the dielectric particles P1 are attracted do not change.

On the other hand, as shown in FIG. 9, in the separation chip 100 of the third modified example, the thickness of the insulation film 103 on the first region 12051 of the teeth portion 1201 is smaller than the thickness of the insulation film 103 on the second region 12052 of the teeth portion 1201. Therefore, ∇E² around the end portions of the adjacent first regions 12051 (here, the concave portions 1260) can be maximized by adjusting a voltage value and a frequency applied between the teeth portions 1201. Therefore, the dielectric particles P1 are attracted to the first region 12051 (here, the concave portion 1260) of the teeth portion 1201. Thus, the dielectric particles P1 are attracted to the center of the teeth portion 1201 in the width direction.

Specifically, as can also be found from the fact that Expression (1) includes a term of ∇E², the dielectrophoresis force is generated in a non-uniform region of an AC electric field. The non-uniform region of the AC electric field indicates a region where intervals between lines of electric force change. In the separation chip 100 shown in FIG. 8, a non-uniform electric field is generated around the corner portions 1127 located at the end portions of the teeth portions 1201 in the width direction. Therefore, a location where the dielectric particles P1 are attracted is uniquely determined to be at the corner portions 1127. Thus, for example, even if the frequency or the like is changed, the position where the dielectric particles P1 are attracted cannot be changed.

On the other hand, in the separation chip 100 of the third modified example shown in FIG. 9, the thickness of the insulation film 103 on the first region 12051 of the teeth portion 1201 is made to be smaller than the thickness of the insulation film 103 on the second region 12052 of the teeth portion 1201, so that the non-uniform region of the AC electric field on the one-side surface 1205 of the teeth portion 1201 relatively changes with respect to the separation chip 100 shown in FIG. 8. For example, by disposing the first region 12051 at any desired position, the location where the dielectric particles P1 are attracted can be set at any desired position. In the third modified example, the location where the dielectric particles P1 are attracted can be set at the center of the teeth portion 1201 in the width direction.

Also, in the separation chip 100 of the third modified example, by forming the step 12053 and/or the concave portion 1260 on the one-side surface 1205 of the teeth portion 1201, the AC electric field can be made to be more non-uniform around a predetermined position on the one-side surface 1205 of the teeth portion 1201. That is, a rate of change in the electric field intensity (gradient of the electric field intensity) around the predetermined position on the one-side surface 1205 of the teeth portion 1201 can be further increased. Therefore, the dielectrophoresis force can be made stronger.

Other effects of the third modified example are the same as those of the above preferred embodiment, the first modified example, and the second modified example.

### Fourth Modified Example

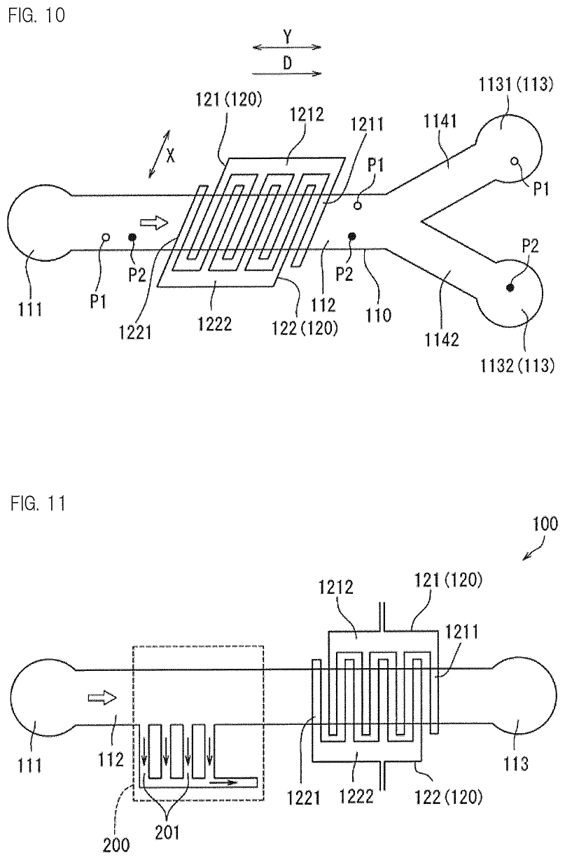

Next, a separation chip 100 according to a fourth modified example will be described with reference to FIG. 10. FIG. 10 is a plan view schematically showing a structure of the separation chip 100 according to the fourth modified example. In the fourth modified example, unlike the above preferred embodiment, the teeth portions 1211 and the teeth portions 1221 of the separation electrode 120 are inclined with respect to the channel 110.

As shown in FIG. 10, in the separation chip 100 of the fourth modified example, the plurality of teeth portions 1211 of the first electrode 121 and the plurality of teeth portions 1221 of the second electrode 122 extend in the first direction X intersecting the flow direction D in which the channel 110 extends. In the fourth modified example, unlike the above preferred embodiment, the first direction X is inclined with respect to the flow direction D, which is the direction in which the sample liquid is to flow. That is, in the fourth modified example, the teeth portions 1211 and the teeth portions 1221 are inclined with respect to the channel 110. With such a configuration, for example, by applying an AC voltage of a specific frequency between the first electrode 121 and the second electrode 122, the dielectric particles P1 can be moved along the teeth portions 1211 and the teeth portions 1221. Therefore, the dielectric particles P1 can be easily separated from the other particles P2. Details will be described below.

In the fourth modified example, the collection portion 113 of the channel 110 includes a first collection portion 1131 and a second collection portion 1132. The first collection portion 1131 collects the dielectric particles P1. The second collection portion 1132 collects the other particles P2. The channel 110 further includes a first connection channel 1141 and a second connection channel 1142. The first connection channel 1141 connects a downstream portion of the separation channel 112 and the first collection portion 1131. The second connection channel 1142 connects a downstream portion of the separation channel 112 and the second collection portion 1132.

In the separation chip 100 of the fourth modified example, by applying the AC voltage of the specific frequency between the first electrode 121 and the second electrode 122, the dielectrophoresis force acts on the dielectric particles P1 passing through the separation channel 112. Consequently, the dielectric particles P1 move along the teeth portions 1211 and the teeth portions 1221. In the fourth modified example, the dielectric particles P1 move toward the first connection portion 1212 along the teeth portions 1211 and the teeth portions 1221.

The dielectric particles P1 pass through the first connection channel 1141 and are collected in the first collection portion 1131. On the other hand, the other particles P2 travel straight through the separation channel 112, pass through the second connection channel 1142, and are collected in the second collection portion 1132.

Other structures and effects of the fourth modified example are the same as those of the above preferred embodiment, and the first modified example to the third modified example.

### Fifth Modified Example

Next, a separation chip 100 according to a fifth modified example will be described with reference to FIG. 11. FIG. 11 is a plan view schematically showing a structure of the separation chip 100 according to the fifth modified example. In the fifth modified example, unlike the above preferred embodiment, an example in which the separation chip 100 includes, for example, an HDF (hydrodynamic filtration) 200 will be described.

As shown in FIG. 11, in the fifth modified example, the separation chip 100 further includes the HDF 200. The HDF 200 is disposed upstream of the separation electrode 120. The HDF 200 functions as a hydrodynamic filter. For example, the HDF 200 is a micro channel that aims at separation and/or concentration of fine particles. The HDF 200 has a plurality of branch channels 201 branching from the separation channel 112. The plurality of branch channels 201 and a part of the separation channel 112 constitute the HDF 200. The plurality of branch channels 201 are disposed, for example, to extend perpendicularly to the separation channel 112. Also, the plurality of branch channels 201 are disposed at substantially equal pitches along the extending direction of the separation channel 112, for example.

The liquid flowing through the separation channel 112 flows into the plurality of branch channels 201. Also, a part of the particles contained in the liquid flowing through the separation channel 112 flows into the plurality of branch channels 201. Specifically, particles having a particle size smaller than a predetermined size flow into the branch channels 201, and particles having a particle size equal to or larger than the predetermined size travel substantially straight through the separation channel 112 without flowing into the branch channels 201. That is, the HDF 200 separates the particles having the particle size smaller than the predetermined size from the liquid flowing through the separation channel 112. In the fifth modified example, the dielectric particles P1 do not flow into the branch channels 201 of the HDF 200, and travel substantially straight through the separation channel 112.

In the fifth modified example, as described above, the separation chip 100 further includes the HDF 200. Hence, the HDF 200 can separate the particles having the size smaller than the predetermined size from the particles contained in the sample liquid, and then the separation electrode 120 can separate the dielectric particles P1 from the particles having the predetermined size or larger.

Other structures and effects of the fifth modified example are the same as those of the above preferred embodiment, and the first modified example to the fourth modified example.

The preferred embodiment of the present invention has been described above with reference to the drawings. However, the present invention is not limited to the above preferred embodiment, and can be implemented in various modes without departing from the gist thereof. Also, various inventions can be formed by appropriately combining a plurality of constituent elements disclosed in the above preferred embodiment. For example, some constituent elements may be deleted from all constituent elements shown in the preferred embodiment. Further, constituent elements of different preferred embodiment and modified examples may be appropriately combined. The drawings schematically show the respective constituent elements as main elements in order to facilitate understanding, and the thickness, the length, the number, the interval, etc., of each constituent element shown in the figures may be different from the actual ones for convenience in creating the drawings. Also, the material, shape, dimension, and the like of each constituent element illustrated in the above preferred embodiment are merely examples, and are not particularly limited, and various modifications can be made without substantially departing from the effects of the present invention.

For example, in the above preferred embodiment, an example in which the dimension in the cross section along the second direction Y is different between the at least one teeth portion 1201 and the other teeth portion 1201 has been described, but the present invention is not limited thereto. For example, the at least one teeth portion 1201 and the other teeth portion 1201 may be different from each other in the cross-sectional shape along the second direction Y and/or the material.

Also, for example, in the above preferred embodiment, an example in which the electrode width W120 in the cross section along the second direction Y is different between the at least one teeth portion 1201 and the other teeth portion 1201 has been described, but the present invention is not limited thereto. For example, the at least one teeth portion 1201 and the other teeth portion 1201 may be different from each other in a thickness (height) in the cross section along the second direction Y.

Also, for example, in the above preferred embodiment, an example in which the electrode portion 12 includes the teeth portion 1201 and the cover portion 1031 has been described, but the present invention is not limited thereto. For example, the electrode portion 12 does not have to have the cover portion 1031.

Also, for example, in the second modified example, an example in which the dimension in the cross section along the second direction Y is different between the at least one cover portion 1031 and the other cover portion 1031 has been described, but the present invention is not limited thereto. For example, the at least one cover portion 1031 and the other cover portion 1031 may be different from each other in the cross-sectional shape along the second direction Y and/or the material.

Also, for example, in the second modified example, an example in which the electrode width W120 in the cross section along the second direction Y is different between the at least one cover portion 1031 and the other cover portion 1031 has been described, but the present invention is not limited thereto. For example, the at least one teeth portion 1201 and the other teeth portion 1201 may be different from each other in a thickness in the cross section along the second direction Y.

Also, for example, in the above preferred embodiment, an example in which the electrode width W120 on the downstream side in the flow direction D is smaller as compared to the electrode width W120 on the upstream side in the flow direction D has been described, but the present invention is not limited thereto. For example, the electrode width W120 on the downstream side in the flow direction D may be larger as compared to the electrode width W120 on the upstream side in the flow direction D.

Also, for example, in the third modified example, an example in which the width W1032 of the opening portion 1032 on the downstream side in the flow direction D is smaller as compared to the width W1032 of the opening portion 1032 on the upstream side in the flow direction D has been described, but the present invention is not limited thereto. For example, the width W1032 of the opening portion 1032 on the downstream side in the flow direction D may be larger as compared to the width W1032 of the opening portion 1032 on the upstream side in the flow direction D.

Also, for example, in the first modified example, an example in which the distance L120 between the electrodes on the downstream side in the flow direction D is smaller as compared to the distance L120 between the electrodes on the upstream side in the flow direction D has been described, but the present invention is not limited thereto. For example, the distance L120 between the electrodes on the downstream side in the flow direction D may be larger as compared to the distance L120 between the electrodes on the upstream side in the flow direction D.

Also, for example, in the above preferred embodiment, ∇E² between the teeth portions 1201 adjacent to each other on the downstream side in the flow direction D is larger as compared to ∇E² between the teeth portions 1201 adjacent to each other on the upstream side in the flow direction D has been described, but the present invention is not limited thereto. For example, ∇E² between the teeth portions 1201 adjacent to each other on the downstream side in the flow direction D may be smaller as compared to ∇E² between the teeth portions 1201 adjacent to each other on the upstream side in the flow direction D.

Although the preferred embodiment of the present invention has been described in detail, these are merely specific examples used to clarify the technical contents of the present invention, and the present invention should not be construed as limited to these specific examples, and the scope of the present invention is limited only by the accompanying claims.

What is claimed is:

1. A separation chip comprising:
a substrate; and
a plurality of electrode portions disposed on one-side surface of the substrate, each of the electrode portions having at least an electrode, and extending in a first direction, wherein the plurality of electrode portions are disposed adjacent to each other in a second direction intersecting the first direction; wherein
a channel through which a liquid containing dielectric particles is to flow in a flow direction intersecting the first direction is provided on one side of the plurality of electrode portions, and
at least one of the electrode portions and another one of the electrode portions are different from each other in at least one of a cross-sectional shape along the second direction, a dimension in a cross section along the second direction, and a material.

2. The separation chip according to claim 1, wherein at least one of the electrodes and another one of the electrodes are different from each other in at least one of a cross-sectional shape along the second direction, a dimension in a cross section along the second direction, and a material.

3. The separation chip according to claim 2, wherein the at least one electrode and the other electrode are different from each other in an electrode width in the cross section along the second direction.

4. The separation chip according to claim 3, wherein the other electrode is disposed downstream of the at least one electrode in the flow direction, and
the electrode width of the other electrode is smaller as compared to the electrode width of the at least one electrode.

5. The separation chip according to claim 1, wherein each of the electrode portions has an insulation layer disposed on one-side surface of the electrode, and
at least one of the insulation layers and another one of the insulation layers are different from each other in at least one of a cross-sectional shape along the second direction, a dimension in a cross section along the second direction, and a material.

6. The separation chip according to claim 5, wherein each of the insulation layers has an opening portion that connects the electrode and the channel, and
the at least one insulation layer and the other insulation layer are different from each other in a width of the opening portion in the cross section along the second direction.

7. The separation chip according to claim 6, wherein the other insulation layer is disposed downstream of the at least one insulation layer in the flow direction, and
the width of the opening portion along the second direction of the other insulation layer is smaller as compared to the width of the opening portion along the second direction of the at least one insulation layer.

8. The separation chip according to claim 6, wherein the one-side surface of the electrode has a first region and a second region different from the first region,
the insulation layer is disposed on the second region,
the first region is connected to the channel through the opening portion, and
the first region is located closer to the substrate than the second region.

9. The separation chip according to claim 1, wherein ∇E² between the electrodes adjacent to each other on the downstream side in the flow direction is larger as compared to ∇E² between the electrodes adjacent to each other on the upstream side in the flow direction, and
∇E indicates a gradient of an electric field intensity.

10. A separation chip comprising:
a substrate; and
a plurality of electrode portions disposed on one-side surface of the substrate, each of the electrode portions having at least an electrode, and extending in a first direction, wherein the plurality of electrode portions are disposed adjacent to each other in a second direction intersecting the first direction; wherein
a channel through which a liquid containing dielectric particles is to flow in a flow direction intersecting the first direction is provided on one side of the plurality of electrode portions, and
a distance between at least one pair of the electrodes adjacent to each other is different from a distance between another pair of the electrodes adjacent to each other.

11. The separation chip according to claim 10, wherein the distance between the other pair of the electrodes of the downstream side in the flow direction is smaller as compared to the distance between the at least one pair of the electrodes on the upstream side in the flow direction.

12. The separation chip according to claim 10, wherein each of the electrode portions has an insulation layer disposed on one-side surface of the electrode,
each of the insulation layers has an opening portion that connects the electrode and the channel,
the one-side surface of each of the electrodes has a first region and a second region different from the first region,
the insulation layer is disposed on the second region,
the first region is connected to the channel through the opening portion, and
the first region is located closer to the substrate than the second region.

13. The separation chip according to claim 10, wherein ∇E² between the electrodes adjacent to each other on the downstream side in the flow direction is larger as compared to ∇E² between the electrodes adjacent to each other on the upstream side in the flow direction, and
∇E indicates a gradient of an electric field intensity.

14. A separation chip comprising:
a substrate; and
a plurality of electrode portions disposed on one-side surface of the substrate, each of the electrode portions having at least an electrode, and extending in a first direction, wherein the plurality of electrode portions are disposed adjacent to each other in a second direction intersecting the first direction; wherein
a channel through which a liquid containing dielectric particles is to flow in a flow direction intersecting the first direction is provided on one side of the plurality of electrode portions,
∇E² between at least one pair of the electrodes adjacent to each other is different from ∇E² between another pair of the electrodes adjacent to each other, and
∇E indicates a gradient of an electric field intensity.
